(19) United States
(12) Patent Application Publication
(10) Pub. No.: US 2025/0006003 A1
(43) Pub. Date: Jan. 2, 2025

(54) METHOD AND SYSTEM FOR CONDUCTING WAGERING

(71) Applicant: Castle Island IP Holding LLC, Charlottesville, VA (US)

(72) Inventors: Daniel FULTON, Charlottesville, VA (US); Alan ROIREAU, Charlottesville, VA (US); Jason SPRINKLE, Charlottesville, VA (US); Joshua LARSON, Charlottesville, VA (US); Brandon BOOKER, Charlottesville, VA (US)

(21) Appl. No.: 18/761,005

(22) Filed: Jul. 1, 2024

Related U.S. Application Data
(60) Provisional application No. 63/524,560, filed on Jun. 30, 2023.
(60) Provisional application No. 63/532,280, filed on Aug. 11, 2023.
(60) Provisional application No. 63/622,678, filed on Jan. 19, 2024.

(51) Int. Cl. G07F 17/32

(52) U.S. Cl. CPC G07F 17/3258; G07F 17/3225; G07F 17/329

(57) ABSTRACT

Improved gaming systems, machines, and methods are provided enabling variable gameplay using variable and/or dynamic reward values. The gaming system includes at least a gaming server and one or more gameplay stations, the gaming server determining a reward value in response to receiving a gameplay request and evaluating an award level of the gameplay request based on a wager pot processing system, the reward value including at least a dynamic value based on a wager pot pool.

### CROSS-REFERENCE TO RELATED APPLICATIONS

This application further claims the benefit of and priority to U.S. Provisional Patent Application Ser. No. 63/524,560 filed on 30 Jun. 2023, U.S. Provisional Patent Application Ser. No. 63/532,280 filed on 11 Aug. 2023, and U.S. Provisional Patent Application Ser. No. 63/622,678 filed on 19 Jan. 2024, which applications are each expressly incorporated herein by reference in their entirety.

### FIELD OF THE DISCLOSURE

The field of the disclosure relates generally to gameplay stations, wagering terminals, and gaming servers, including gaming consoles, gaming machines or networked gaming machines, such as gameplay stations, wagering terminals, and gaming servers found in casinos or betting environments, and related methods of operation.

### BACKGROUND

Within the gambling or gaming industry, including sports betting, esports betting, games of chance, etc., traditional gaming machines include slot machines, poker machines, video lottery terminals, gaming consoles, and similar devices. These traditional gaming machines are configured to provide an interface for wagering on game events and have proven popularity. However, players quickly become tired of various adaptations of existing gaming machines, requiring the development of new and inventive ways to represent or play games on such gaming machines. For this reason, game creators must continually invent new and innovative ways to represent games and gameplay to stimulate players and encourage further interest.

Gaming or in other words, wagering, in the United States is generally categorized into class I, class II and class III for the purposes of regulation, with class I gaming being defined as traditional tribal gaming subject to the least regulation, and class III gaming being subject to the greatest regulation and broadly encompassing all forms of gaming that are neither class I or II (e.g. casino or table games such as slot machines, blackjack, craps, roulette, etc.).

Class II gaming includes the game commonly referred to as bingo, whether or not electronic, computer, or other technological aids are used in connection with the game and non-banked card games. In traditional bingo, players purchase cards that include different arrangements of tokens, such as numbers or other symbols, in a grid or other pattern. A caller randomly selects tokens from a token pool and players match the called tokens to their cards. When the matched tokens on a player's card form certain predetermined patterns or arrangements, such as a line, only corners, a completely filled card or other arrangement, the card may be identified as a winning card and scored accordingly, such that a corresponding reward or prize may be disbursed. A number of winning arrangements may be possible, such that a winning card may or may not conclude the game.

Unfortunately, despite the modernization of several aspects of class II gaming, further expansion of class II gaming is limited by regulatory constraints and traditional aspects of bingo.

In view of the foregoing, there is a need for improved gaming systems and methods that improve gameplay and management of class II games without losing the regulatory advantages associated with class II gaming. There is further a need for gaming systems and methods that enable the creation of new forms of gameplay for class II games, without increasing the processing requirements of a gaming terminal or gaming systems.

### SUMMARY

The embodiments disclosed herein are directed to providing improved gaming systems and methods that address the problems above and enable an advantage of improved variability and enjoyment in class II gaming.

A gaming system is provided including one or more gameplay stations and a gaming server. The gameplay stations may include a user interface and the gaming server may be provided in network communication with the one or more gameplay stations through a communications interface. The gaming server may comprise a memory and a processor configured for executing instructions stored on the memory to perform the following steps: receiving a gameplay request from the one or more gameplay stations, evaluating the gameplay request based on one or more corresponding award levels from a score sheet, and determining a reward value for the gameplay request using the one or more corresponding award levels and a wager pot processing system, wherein the one or more corresponding award levels include at least a dynamic value based on a wager pot pool of the wager pot processing system.

A method is provided comprising receiving a gameplay request from the one or more gameplay stations, evaluating the gameplay request based on one or more corresponding award levels from a score sheet, and determining a reward value for the gameplay request using the one or more corresponding award levels and a wager pot processing system, wherein the one or more corresponding award levels include at least a dynamic value based on a wager pot pool of the wager pot processing system.

These and other features of the disclosure will become better understood by reference to the following description, appended claims, and accompanying drawings.

### BRIEF DESCRIPTION OF THE DRAWINGS

FIG. 1 is a diagrammatic view of a gaming system according to an embodiment of the disclosure.

FIG. 2 is a diagrammatic view of a gameplay station according to an embodiment of the disclosure.

FIG. 3 is a diagrammatic view of a gaming server according to an embodiment of the disclosure.

FIG. 4 is an illustration of an evaluation of a gameplay request according an embodiment of the present disclosure.

FIG. 5 is an illustration of a wager pot processing system according an embodiment of the present disclosure.

FIG. 6 is an illustration of a wager pot processing system according an embodiment of the present disclosure.

FIG. 7 is an illustration of a wager pot processing system according an embodiment of the present disclosure.

The figures are not necessarily drawn to scale, but instead are drawn to provide a better understanding of the components, and are not intended to be limiting in scope, but to provide exemplary illustrations. The figures illustrate exemplary configurations of a system and method for gaming, and in no way limit the structures, configurations, or methods of the system and method for gaming according to the present disclosure.

### DETAILED DESCRIPTION OF VARIOUS EMBODIMENTS

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. The dimensions, angles, and curvatures represented in the figures introduced above are to be understood as exemplary and are not necessarily shown in proportion. It should be understood, however, there is no intention to limit the disclosure to the specific embodiments disclosed, but on the contrary, the intention covers all modifications, alternative constructions, combinations, and equivalents falling within the spirit and scope of the disclosure.

The flowchart illustrations and block diagrams in the flow diagrams illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s).

It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart illustrations and/or block diagram block or blocks.

The disclosed embodiments relate to systems and methods for gaming that overcome the problems of static gameplay and rewards in existing gaming machines and provide an improved experience for players. The disclosure outlines some example improvements and practical applications provided by the disclosed embodiments. These are just examples only and the embodiments are not limited to only these improvements.

As used in the present disclosure, a “local connection” or “local communications interface” is generally used to refer to a direct connection by means of a network, whether wired or wireless, or similar means that does not require or otherwise involve the use of an internet or other third-party data connection.

As referenced in the examples of the current disclosure, a “game,” “active game,” “existing game,” and/or “new game” may be used to refer to a bingo call or another set of parameters governing results of a wager. A player or gameplay request entering or being assigned to a game generally refers to applying the call associated with the game to a wager associated with the player or gameplay request.

Embodiments of a gaming system and related methods are provided for improving gameplay and management of class II games without losing the regulatory advantages associated with class II gaming. Further, the creation of new forms of gameplay for class II games is enabled, without increasing the processing requirements of a gaming terminal or gaming system.

The disclosed embodiments operate to improve how a gaming machine comprising a computing device operates and/or functions. For instance, the disclosed embodiments are able to automatically increase the variety and variability of rewards available for gaming while reducing management requirements by following the disclosed principles. Furthermore, the processing speed and operational efficiency of the gaming system can be improved. As a consequence, the disclosed embodiments operate to improve the computing efficiency and resource utilization of a gaming system and related computing architecture. As an additional example, by varying an entertaining display based on the reward values and the result of the player's wager, the disclosed embodiments will also improve the presentation of the game to a player.

The disclosed embodiments may be implemented in various configurations for gaming machines, gaming devices, or gaming systems, including but not limited to: (1) a dedicated gaming machine, gaming device, or gaming system wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment.

In embodiments, the computerized instructions for controlling games may be executed by at least one central server, central controller, or remote host. In such a “thin client” embodiment, the central server remotely controls any games (or other suitable interfaces) and the gaming machine is utilized to display such games (or suitable interfaces) and receive one or more inputs or commands from a player. In another embodiment, the computerized instructions for controlling games may be communicated from the central server, central controller, or remote host to a gaming machine's local processor and memory devices. In such a “thick client” embodiment, the gaming machine's local processor executes the communicated computerized instructions to control any games (or other suitable interfaces) provided to a player.

Several (or different) elements discussed below, and/or claimed, are described as being “coupled”, “in communication with”, “in network communication”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis.

The methodologies described herein may be implemented by various means depending upon applications according to particular examples. For example, such methodologies may be implemented in hardware, firmware, software, or combinations thereof. In a hardware implementation, for example, the controller or processing unit may be implemented within one or more application specific integrated circuits (“ASICs”), digital signal processors (“DSPs”), digital signal processing devices (“DSPDs”), programmable logic devices (“PLDs”), field programmable gate arrays (“FPGAs”), processors, controllers, micro-controllers, microprocessors, electronic devices, other devices units designed to perform the functions described herein, or combinations thereof.

Some portions of the description included herein are presented in terms of algorithms or symbolic representations of operations on binary digital signals stored within a memory of a specific apparatus or special purpose computing device or platform. In the context of this particular specification, a specific apparatus or the like includes a general-purpose computer once it is programmed to perform particular operations pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities.

Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals, or the like. It should be appreciated, however, that all of these or similar terms are to be associated with appropriate physical quantities and are merely convenient labels. Unless specifically stated otherwise, as apparent from the discussion herein, throughout this specification discussions utilizing terms such as “processing,” “computing,” “calculating,” “determining” or the like refer to actions or processes of a specific apparatus, such as a special purpose computer or a similar special purpose electronic computing device. In the context of this description, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

For clarity in discussing the various functions of the system, multiple computers and/or servers are discussed as performing different functions. These different computers (or servers) may, however, be implemented in multiple different ways such as modules within a single computer, as nodes of a computer system, etc. The functions performed by the system (or nodes or modules) may be centralized or distributed in any suitable manner across the system and its components, regardless of the location of specific hardware. Furthermore, specific components of the system may be referenced using functional terminology in their names. The function terminology is used solely for purposes of naming convention and to distinguish one element from another in the following discussion. Unless otherwise specified, the name of an element conveys no specific functionality to the element or component. In selected embodiments, the software, hardware, and associated components of the system may be programmed and configured to implement one or more embodiments described herein. The various aspects of the system may be exemplified as software, modules, nodes, etc. of a computer or server device.

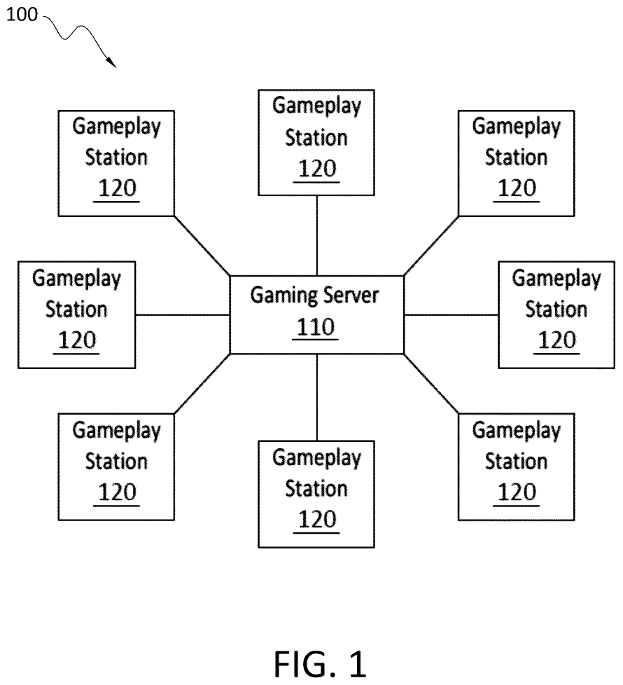

FIG. 1 illustrates an embodiment of a gaming system 100 including a gaming server 110 in communication with a plurality of gameplay stations 120 for enabling players to participate in gaming. The gaming system 100 may be configured to provide the gaming server 110 and the plurality of gameplay stations 120 in the same general location or may be configured to provide the gaming server 110 and the plurality of gaming stations 120 in remote locations.

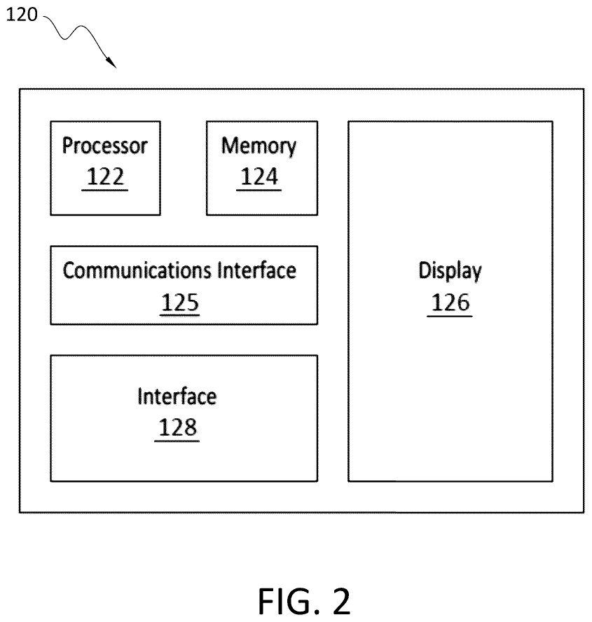

As illustrated in FIG. 2, each of the plurality of gameplay stations 120 may include a processor 122 and a memory 124 for operating a corresponding display 126 and a corresponding user interface 128. In operation, each gameplay station 120 is arranged to facilitate an input by a player, such that a corresponding gameplay request is sent by a communications interface 125 from the gameplay station 120 to the gaming server 110. The user interface 128 may include a keyboard, touch screen, card reader or other value receiving device, speakers, microphones, or any other suitable or related components.

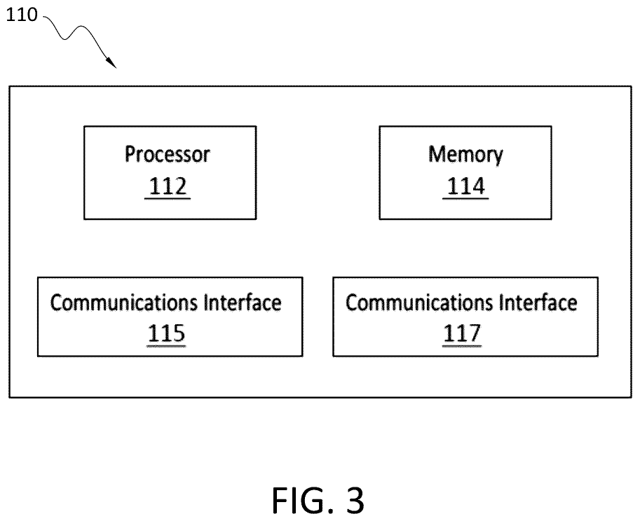

An embodiment of a gaming server 110 is shown in FIG. 3, including a processor 112, a memory 114 and a communications interface 115, for managing one or more games thereon. The gaming server 110 may be configured for receiving a gameplay request of a gameplay station 120 by means of the communications interface 115 and adding the gameplay request to a game.

According to another aspect of the disclosure, the communications interface 115 of the gaming server 110 and/or the communications interface 125 of the gameplay stations 120 may facilitate only a local connection, or may be provided as local communications interfaces, such that the use of an internet connection, internet service provider (ISP) or other third-party data connection is not required for communications between the gaming server 110 and the plurality of gameplay stations 120. In various embodiments, the communications interfaces 115, 125 may be restricted to short distance communications. According to various embodiments, the gaming server 110 may be provided with a communications interface 117 for remote management, maintenance or monitoring of the gaming system 100 and/or the communications interface 125 of the gameplay stations 120 may facilitate a local connection or may be provided as local communications interfaces. For example, communications interface 117, 125 may include an internet connection or other third-party data connection, such as for processing payments made by a player or for other communications.

According to alternative embodiments, the gameplay stations 120 and the gaming server 110 may be implemented in a single computing system, such that the gameplay stations 120 are integrated into a single device with or without the gaming server 110 also implemented thereon. In integrated embodiments, the gaming server 110 and the gameplay stations 120 may be operated using the same processor and/or the same memory with a plurality of user interfaces 128 and/or communications interfaces 115, 117, 125.

It is noted that one, more or each of the functions of a gaming server, central controller, central server or remote host as disclosed herein may be performed by one or more gameplay stations, such as by one or more processors of one or more gameplay stations. It is further noted that one, more or each of the functions of one or more gameplay stations as disclosed herein may be performed by the central gaming server, controller, central server or remote host.

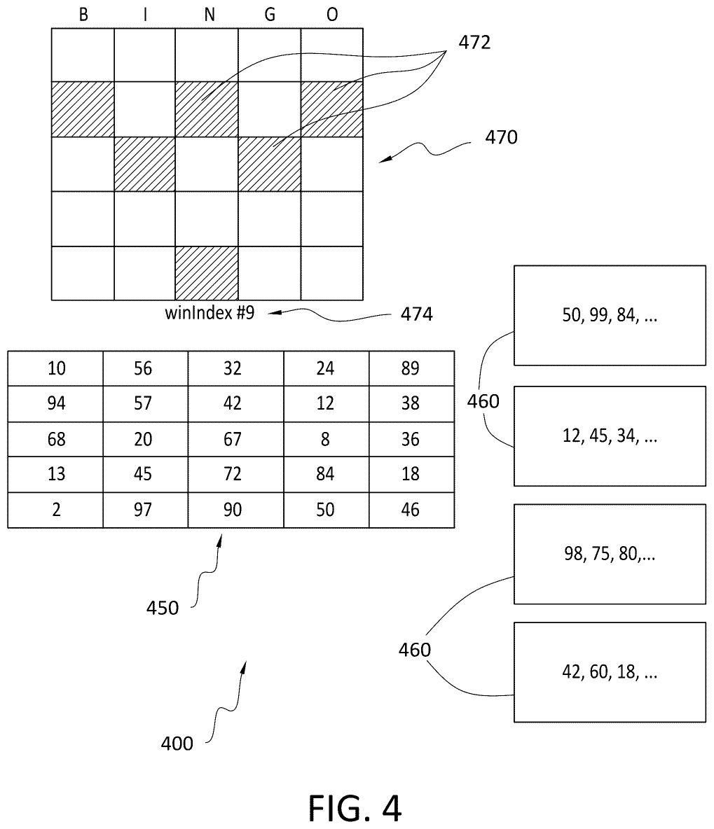

Embodiments of the disclosure may be directed to games facilitated as bingo games, as illustrated in FIG. 4. Accordingly, the gaming server 110 may comprise a bingo gaming server, such that the gaming server 110 creates and manages bingo games using gameplay requests received from the gameplay stations 120. Each gameplay request provided from a gameplay station 120 may include a card 450 including a different arrangement of tokens, for example corresponding to a player's purchase of a card 450 through the user interface 128, and/or a wager amount. The player may initiate a game and may place a wager by any suitable method, such as by transferring money or credits to the gaming system 100. At least one or a plurality of input devices of the gaming system 100 may be used to facilitate the wager and the gaming system 100 may accept the wager.

The card 450 may include a random selection and arrangement of tokens from a token pool and may be selected from a plurality of cards 450 for assignment to the gameplay request or randomly generated for each gameplay request. According to varying embodiments, the gameplay request received by the gaming server may include a corresponding card 450 or may be assigned a card 450 upon receipt at the gaming server 110. Accordingly, a gameplay request may include a single card 450 or a plurality of cards 450 for use in a bingo game, such that each gameplay request may correspond to a single wager or a plurality of wagers for evaluation in a game.

Various forms of card assignment or selection may be used. The cards may take varying forms, including a random arrangement of any number of tokens, symbols, numbers or otherwise, such as in a grid pattern, a line or other arrangement. The card 450 may be selected from a plurality of cards for assignment to the gameplay request or randomly generated for each gameplay request, such as using a random number generator.

In certain embodiments, a player may create or select a card by selecting a desired arrangement of specific tokens or the like. In some examples, a card may have the form of a standard bingo card comprising numbers arranged in a 5-by-5 grid, but the embodiments are not limited thereto and may include cards of differing size and/or arrangements. While the card 450 may or may not be presented to a player in the display 126 of the gameplay station 120, the underlying card may be represented in a gameplay request 450 communicated to or assigned by the gaming server 110 in a digital, numerical, referential or other form.

In embodiments, the assignment or selection of a card may be limited to prevent the same card being used in the same game. For example, assignment or selection of a card may be restricted to only cards that have not yet been used in a game. In an alternative embodiment, assignment of a gameplay request to an existing game may be made by taking into account whether a card of the gameplay request has been used in said existing game previously, such that a card can be used only once for an associated call or game. Alternatively, for example where a card is randomly generated or selected for each gameplay request, identical cards may occur.

In addition to the assignment or selection of a card, the gameplay request may include a wager amount as input by a player. In varying forms of the gaming system, the player may select a predefined wager or enter a custom wager using the user interface 128, for example by means of a card reader or other reader for receiving objects of value. The wager may accompany the gameplay request to the gaming server or be retained in the gameplay station, for communication or resolution after a result of a given card is determined.

In one aspect of the disclosure, the gaming server 110 of the system 100 may include databases, terminals, and computing devices to manage one or more wager pot pools in a wager pot wagering environment. In certain aspects, the gaming server 110 may employ a wager pot processing system for accepting and processing wagers of one or more players, making wager pot pool allocations, calculating odds and prices of wagers, calculating the commission for the operator, and distributing winnings. Rewards may be distributed to players based on a predetermined score sheet including specified patterns, calls, and award levels that are associated with a wager pot pool of the wager pot processing system. The gaming server 110 may maintain separate math models and separate wager pot pools for different wager denominations, specified patterns, calls, and/or wager levels offered by each model.

Each game 460 on the gaming server 110 may include a call 460, for example including randomly selected tokens from a token pool, such that the gaming server 110 compares the gameplay request 450 or card of the player to a call or game 460. In certain aspects, the call or game 460 may be pending on the gaming server 110 before the gameplay request 450 is received or created in response to the gameplay request 450. The gaming server 110 may further select a game call or ball call 460, including randomly selected tokens from a token pool or a randomly selected grouping of tokens, such as using a random number generator.

When the tokens on the player's card matching the call of the game 460 form one of a plurality of certain predetermined patterns or arrangements, the card of the gameplay request 450 may be identified as a winner and may be scored against a predetermined score sheet such that a final result with a corresponding reward may be disbursed to the player at the gameplay station 120. Alternatively, when the tokens on the player's card matching the call of the game 460 do not form one of the plurality of predetermined patterns or arrangements, the gameplay request 450 may be discarded and the final result may not include a reward being provided to the player.

To define a score sheet 470 according to an embodiment of the current disclosure, the processor may consider specific patterns of matched or daubed tokens 472 relative to a size, shape, and/or layout of the cards. A reward 474 may be tied to matching only a specified pattern without any additional tokens being daubed (i.e., requiring that both positive daubs and non-daubs are matched) or to matching the specified pattern regardless of other tokens being daubed (i.e., requiring only that positive daubs are matched). In various embodiments, the score sheet may be defined by a pattern and by a number of balls called to match the pattern. Different patterns and/or a number of balls needed to match the pattern may be included in the score sheet 470 and may be tied to different award levels 474. While described as a score sheet 470, varying embodiments may employ other approaches to evaluate a gameplay request or wager. As such, no specific architecture is required for evaluating a player's gameplay request or wager.

The player's card 450 may be submitted to the server 110 for comparison to the ball call 460 and/or the score sheet 470 of the gaming system 100 or may be evaluated at a gameplay station 120. In varying embodiments, the score sheet may include a pay table wherein the pay table may identify which patterns are available for comparison to the player's card based on the wager provided by the player. If there is an available pattern that is a match with the card of the player based on the corresponding ball call of the game, a final result of the corresponding wager may be used to determine the reward associated with the score sheet 470. The score sheet 470 may provide static rewards for the predetermined patterns and/or may be dynamically adjusted based on the circumstances of the game and/or the gaming system.

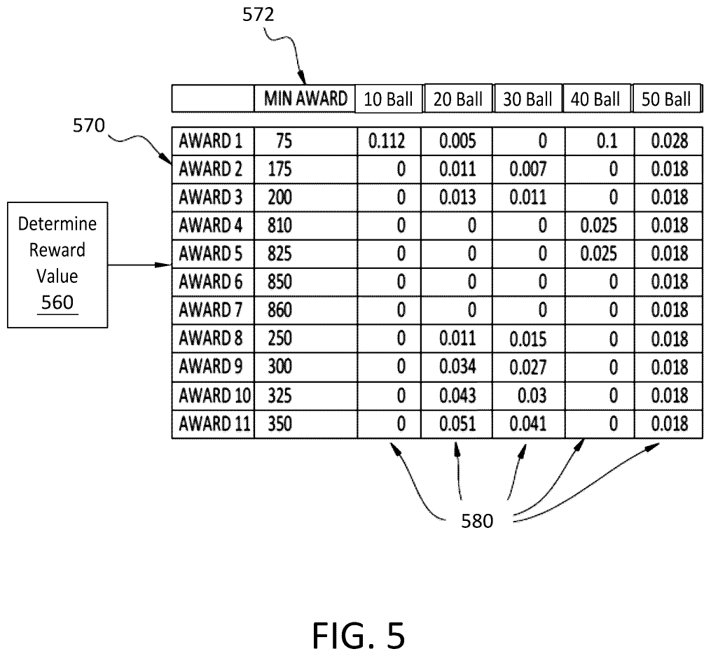

The gaming server 110 may be arranged to dynamically determine a reward value associated with the final result based on an award level of the final result indicated in the score sheet and a value of one or more corresponding wager pot pools. In determining the reward value 560 according to the embodiment of FIG. 5, each specified pattern of the score sheet may be associated with an award level 570 having a minimum award value 572 and one or more award rates 580, such that the marginal rate of a reward may vary as the total wager pot pool value increases or decreases.

In certain embodiments, the award rates may correspond to a number of balls called before the pattern was matched, although other arrangements are considered where the award rates correspond with a number of wins in a row, where the award rates correspond with a wager level or value, where the award rates correspond to different wager pot pools, where only one award rate is provided per specified pattern, where one or more minimum award values are zero, where the minimum award values are only used when the minimum value is greater than a reward value based on the award rate alone, where the minimum award value is a dynamic value, or another arrangement for determining dynamic rewards. When the player's card, after evaluation relative to the ball call, matches a specified pattern of the score sheet, the gaming server may identify the award level 570 of the specified pattern and identify the one or more award rates 580 associated with the award level.

The reward value for the specified pattern of the score sheet may comprise the minimum award value 572 of the award level 570 and one or more additional values determined by applying the one or more award rates 580 of the award level 570 to one or more wager pot pools. The reward value may be described as equal to (Min Award)+Σ_{N=1}^{MaxBallCount}(ValueOfWagerPotPool)*(AwardsRateN). In other embodiments, the reward value for the specified pattern of the score sheet may comprise the minimum award value 572 of the award level 570 or one or more additional values determined by applying the one or more award rates 580 of the award level 570 to one or more wager pot pools.

In the example of FIG. 5, a reward value based on a card matching a pattern of the score sheet having an award level 770 equal to AWARD 8 may be determined as =(250)+(807)*(0)+(23409)*(0.011)+(26745)*(0.015)+(4594)*(0)+(0)*(0.018)=908. It is noted that the example of FIG. 5 is merely exemplary, and the minimum awards, award rates and award levels may be rearranged, added to, included or excluded, and otherwise modified within the spirit and scope of the disclosure.

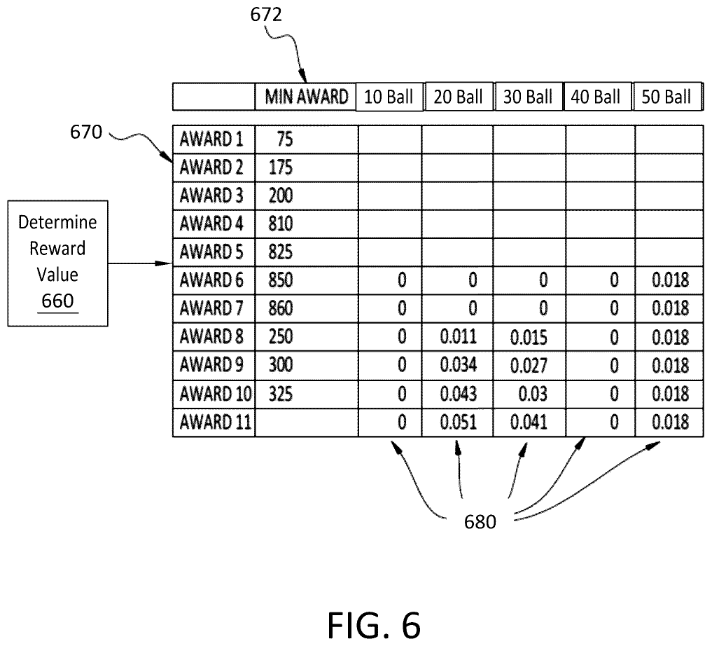

According to varying aspects of the disclosed embodiments, only certain award levels or rates may be enabled based on one or more of a player's choice, a wager value, or a predetermined set of patterns from the score sheet. In the example of FIG. 6, a reward value 660 may be determined based on award levels 670 representing a mixture of static, static and variable, and only variable reward values. According to the depicted example, award levels 1-5 provide only a static reward value based on the minimum award 672 without any variable award rates, while award levels 6-10 provide both a static reward based on the minimum award 672 and a variable reward based on the award rates 680, and award level 11 provides only a variable reward based on the award rates 680. Such a varied approach to reward values can allow for greater excitement and variability in a game, enabling a player to pursue a particular pattern win based on the respective reward value and/or enabling a provider to advertise a larger reward value for certain patterns, such as a game ending pattern, to attract more players to the game. In varying embodiments the minimum award values may be dynamic values, or may be a combination of dynamic and static values, or some minimum award values may be static while other minimum award values may be dynamic. Different arrangements and combinations of static and dynamic or variable rewards may be used, and the example of FIG. 6 is only illustrative of principles thereof.

As mentioned, only certain award levels or rates may be enabled based on one or more of a player's choice, a wager value, or a predetermined set of patterns from the score sheet. For example, certain wager values and/or denominations may be associated with enabling different award levels for the player's wager. In like manner, a game may be adjusted by a provider and/or by a player's choice to associate certain award levels with static and/or variable rewards based on the pattern associated with that award level in the score sheet. In one example, one or more of a scatter pattern, a checkerboard pattern, a bottom V pattern, a crazy 7 pattern or another pattern may be associated with a variable wager pot reward while other patterns are associated with a static reward value. Similarly, each pattern or certain patterns may be associated with different player wager pot pools, in a wager pot pool per pattern arrangement or the like.

Given the variety of options discussed above, it is possible to enable a player to select one/or more patterns, award levels or the like to enable for a given game or wager. Players may thereby be enabled to experience a feeling of greater control, involvement, and strategy in the game, increasing the entertainment value of the game while still minimizing management complexity and commission uncertainty for the provider.

A further example is explained below with respect to a player's card matching a “Ramp” pattern on 16 balls called. In this example, since 16 is less than 19 and greater than 14 the player award level is determined as the winIndex (32) associated with maxBalls=19.
<pattern name=“Ramp”>
<win maxBalls=“14”
   winIndex=“15”/>
<win maxBalls=“19”
   winIndex=“32”/>
<win maxBalls=“28”
   winIndex=“20”/>
</pattern>

This winIndex is now evaluated by the wager pot processing system which may have a setting for each winIndex, each winIndex corresponding to a minimum reward value and a tier value representing a percentage of the player wager pot pool. In this example winIndex (32) has a min Value setting of 20 and the tier is 0.01 of the player wager pot pool.
<Win id=“32”>
   <MinValue>20</MinValue>
   <Tiers>0.01</Tiers>
</Win>

Using a wager pot pool value of $26,000, 0.01*$26,000=$26, therefore the player has won a reward value of 26 credits (e.g., at $1 denomination). If the wager pot pool value was low, for example $1,000, then 0.01*1,000=10 which is less than the min Value (20) so the min Value is provided as the reward value. In varying embodiments, the minimum value may always be provided as part of a reward value or may only be provided as part of the reward value when a corresponding tier value applied to the player wager pot pool is less than the minimum value.

The described systems can be configured to only pay in specific increments to accommodate different denominations used and/or currencies. For example, if the game could only pay in quarters then the system can adjust the 26 credit award to 25 credits (1 quarter at $0.01 denomination). Notably, different denominations may be associated with different wager pot pools, such that players may make a strategic denomination selection based on the respective wager pot pool values and associated award levels.

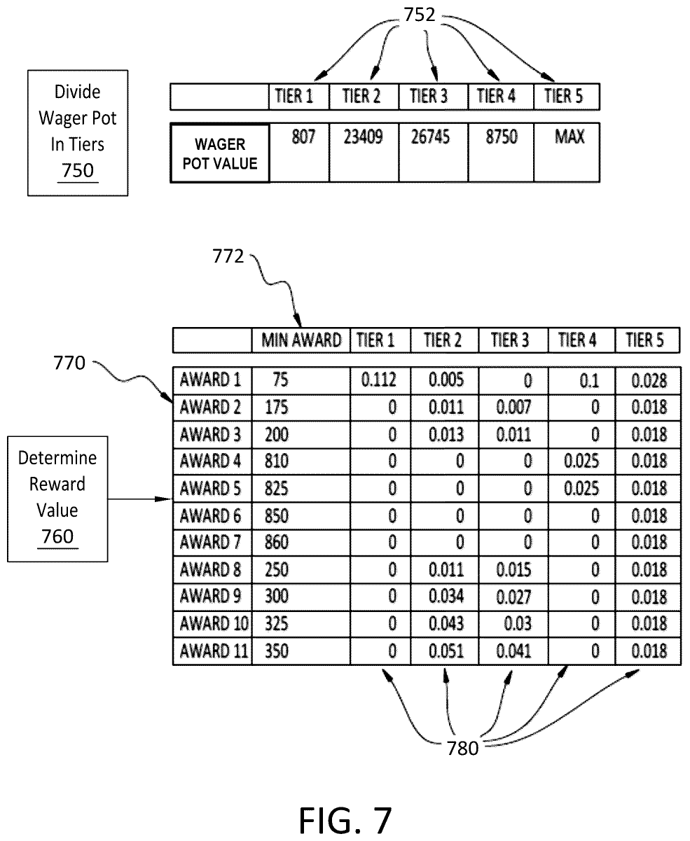

In another example according to FIG. 7, the wager pot processing system may be arranged to dynamically determine a reward value associated with the score sheet based on an award level of the score sheet and a plurality of wager pot pool tier levels 752. As illustrated in FIG. 7, the wager pot processing system may be configured to divide a total wager pot pool value into a plurality of tier levels 752 having predetermined values 750. The tier levels 752 may be filled progressively as wager values are added to the wager pot pool, such that a first tier is filled prior to filling a second tier.

According to the example of FIG. 7, a wager pot pool value of 55,555, for example 55,555 dollars, points or another value representation, may break down into 5 tiers with tier 1=807; tier 2=23409; tier 3=26745; tier 4=4594; and tier 5=0. In some embodiments, the tier levels 752 may be selected with each tier level having a different size, such as a decreasing size at higher tier levels. A decreasing size at higher tier levels allows higher variability in the number of tier levels 752 filled as the total wager pot pool increases, incentivizing variability in gameplay as the stakes and number of players increase. Alternatively, the tier levels 752 may have an increasing size at higher tier levels, causing more variability at low total wager pot pool values in order to incentivize more wagers and more quickly grow the wager pot pool.

In the step of determining the reward value 760, each pattern of the score sheet may be associated with an award level 770 having a minimum award value 772 and a plurality of award rates 780 corresponding to each of the tier levels 752, such that the marginal rate of a reward varies as the total wager pot pool value increases or decreases. When the comparison of a player's card and a ball call matches a pattern of the score sheet, the wager pot processing system may identify the award level 770 of the pattern and identify one or more award rates 780 associated with the award level, the award rates 780 corresponding with the plurality of tier levels 752.

The reward value for the matched pattern from the score sheet may comprise the minimum award value 772 of the award level 770 and one or more tier level values determined by applying the plurality of award rates 780 of the award level 770 to each of the corresponding tier levels 752. For example, the reward value may be described as equal to (Min Award)+Σ_{N=1}^{MaxTierNumber}(ValueOfTierN)*(AwardsRateOfTierN).

In the example of FIG. 7, a pattern from the score sheet having an award level 770 equal to AWARD 8 may be determined as =(250)+(807)*(0)+(23409)*(0.011)+(26745)*(0.015)+(4594)*(0)+(0)*(0.018)=908. It is noted that the example of FIG. 7 is merely exemplary, and the minimum awards, award rates, tier levels and award levels may be rearranged, added to, included or excluded, and otherwise modified within the spirit and scope of the disclosure.

Rather than using only a static rate, value or award for determining reward values associated with a given outcome, the dynamic determination of the reward value according to the present disclosure allows for changes as the value of one or more wager pot pools increases or decreases as well as a possible marginal rate for each award level. Notably, disclosed embodiments can allow for a mix of static, semi-static and fully variable reward values as desired to design optimal game play experience. As the one or more wager pot pools change in value over time so may the portion of the respective wager pot pool(s) that is awarded for individual bingo pattern achievements, thus allowing for an additional level of intrigue as players may adjust their choice of wager pot pools to join as part of their strategy for targeting their preferred bingo patterns.

The dynamic determination of the reward value advantageously introduces new variation into gameplay without increasing processing requirements, and can increase player engagement, enjoyment and participation. By varying the award rates for the specified patterns/calls, or award levels, as the total wager pot pool value increases a player is continuously presented with changing gameplay reflective of the wagers of other players that pay into the wager pot pool. The varying award rates of the award levels can increase the relative value of different patterns/calls and motivate the player to change the objective of their wager, such as from one pattern or wager denomination to another, depending on the wager pot pool value and the associated award levels. Accordingly, a user's engagement and enjoyment are increased, leading to increased participation in gaming and additional wagers.

In like manner, the dynamic determination of the reward values increases the control of a provider over the wager pot pool values, such that automatic variations in reward values can be implemented to increase player engagement and maintain necessary wager pot pool reserves. These dynamic rewards and engaging variations in gameplay for players are advantageously realized while surprisingly increasing predictability for the provider. This is due to the dynamic rewards being based on a player wager pot pool rather than being banked by the house, meaning that the provider can set a rake or commission based on one or more of a player's wager value, a wager pot pool value, and a reward value. This means that a value of the provider's rake or commission can be readily predicted or estimated based only on the number of players and/or games played, such as independent of wager odds for the game as would occur for static reward values alone.

In addition to adding predictability, methods of the current disclosure further ensure a profit for the provider by eliminating the possibility of a game where the provider is responsible for payment of a win beyond the wager pot pool values. In the prior art, a chance exists that a provider may have an “upside-down” game, where the provider owes payouts to players that can not only diminish the provider's commission but require the provider to pay additional funds beyond their commission, thus operating at a loss. This can occur when players win early or close together, meaning that a provider must pay winnings before revenue has grown to suitable levels. In contrast to the prior art, the methods of the current disclosure eliminate the chance of an “upside-down” game where the provider would not only make no profit from operating the game but also be responsible for payment of additional funds, i.e., incurring a loss for operating the game.

The wager pot processing system may be configured to charge a rake or commission but is also able to accommodate a secondary rake or commission (and/or 3^{rd}, 4^{th}, etc.) as needed or desired by a provider. The rake or commission may be set to be a percentage of the total wagers placed but may also be configured to be or include a portion from rounding of player reward values. This advantageously results in a constant profit for the provider. For example, if a commission rate is set to 5% one can quickly predict that, with no variability, for every $100 wagered on the gaming system the provider will be paid $5 in commission. This allows for greatly improved planning of game placement and budgeting activities of the provider relative to prior art systems.

The use of the award levels also enables the gaming system to use a single wager pot pool for a plurality of award levels or to form a plurality of wager pot pools associated with each award level or to use two or more wager pot pools each associated with a group of award levels. According to the present disclosure, a player may also be enabled to place multiple wagers using the same wager pot pool. Multiple wagers may correspond to different patterns/calls, or award levels, allowing for further variation in gameplay using the same card and/or call and reducing the amount of data required to maintain the gaming system. The use of multiple wagers on the same card and/or call with a single wager pot pool further provides advantages in certain regulatory schemes, such as by decreasing tax burdens on players and regulatory reporting requirements for providers.

The gaming system may create and/or select an entertaining display corresponding to the final result of the player's wager, based on whether a pattern is found that is a match with the card of the player based on the corresponding ball call of the game, which pattern was a match, how many balls were required before the match, and/or the reward value won. The entertaining display may break the value won into multiple animations or bonus games. Breaking the value won into multiple animations or bonus games can increase the enjoyment and successful feeling of the player and encourage continued gaming.

In some embodiments, the entertaining display may include a separate component (not shown), such as a separate display screen or mechanical element. The separate components may include a video display, window or a mechanical element corresponding to a plurality of possible results of the player's wager. During the presentation of the entertaining display, a portion of the gaming device may remain dedicated to illustrating features of the bingo game 400.

The entertaining display may be based on a theme or a secondary game. The theme or secondary game may be selected by a player based on preference and/or may be manipulated by the processor in response to a particular final result of a wager and/or a reward value available for a wager. The theme or secondary game may include accompanying depictions and animated highlights of a winning game as the participants complete the wager. The entertaining display may include matches with graphics, symbols, and other indicia particular to the theme or the secondary game.

The wager may end with a payout, beginning another wager, another round, a bonus game, and/or by reverting to a menu providing additional options for the player.

By providing a gaming system and method for using the same according to the disclosed embodiments, the requirements of existing gaming systems including static reward values and unpredictable earnings for providers are addressed. The gaming system embodiments provided herein advantageously allow a prospective player to play a bingo game with variable and dynamic reward values, thereby increasing a player's enjoyment of the gaming machine generally, while meeting the regulatory requirements and retaining the advantages of class II gaming.

While the invention has been illustrated and described in detail in the drawings and foregoing description, the same is to be considered as illustrative and not restrictive in character, it being understood that only the preferred embodiments have been shown and described and that all changes, equivalents, and modifications that come within the spirit of the inventions defined by following claims are desired to be protected.

Accordingly, features of the disclosed embodiments may be combined or arranged for achieving particular advantages as would be understood from the disclosure by one of ordinary skill in the art. Similarly, features of the disclosed embodiments may provide independent benefits applicable to other examples not detailed herein.

It is to be understood that not necessarily all objects or advantages may be achieved under any embodiment of the disclosure. Those skilled in the art will recognize that the disclosed gaming system and related methods may be embodied or carried out in a manner that achieves or optimizes one advantage or group of advantages as taught without achieving other objects or advantages as taught or suggested.

The skilled artisan will recognize the interchangeability of various disclosed features. Besides the variations described, other known equivalents for various features can be mixed and matched by one of ordinary skill in this art to make or use a gaming system and related methods under principles of the present disclosure. It will be understood by the skilled artisan that the features described may be adapted to other types of systems, games and regulatory requirements.

Although this disclosure describes certain exemplary embodiments and examples of a gaming system and related methods, it will be understood by those skilled in the art that the present disclosure extends beyond the specifically disclosed embodiments to other alternative embodiments and/or uses of the disclosure and obvious modifications and equivalents thereof. It is intended that the present disclosure should not be limited by the particular disclosed embodiments described above.

The disclosure further relates to several embodiments as identified by the below numbered embodiments. The present invention is in no way limited to the embodiments described by way of example and represented in the embodiments, and the embodiments are provided only to demonstrate non-limiting examples of possible embodiments of the disclosure.

1-1. A gaming system comprising:
one or more gameplay stations, the gameplay stations including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on one or more corresponding award levels from a score sheet; and
determine a reward value for the gameplay request using the one or more corresponding award levels and a wager pot processing system;
wherein the one or more corresponding award levels include at least a dynamic value based on a wager pot pool of the wager pot processing system.

1-2. The gaming system of any one or a combination of two or more of 1-1 above and 1-3 to 1-10 below,
wherein the gameplay request comprises at least a bingo card and a bingo call, and
wherein the score sheet comprises specified card patterns with the one or more corresponding award levels for determining the reward value.

1-3. The gaming system of any one or a combination of two or more of 1-1 to 1-2 above and 1-4 to 1-10 below, wherein the award levels comprise a percentage value of the wager pot pool.

1-4. The gaming system of any one or a combination of two or more of 1-1 to 1-3 above and 1-5 to 1-10 below, wherein the award levels comprise a percentage value of the wager pot pool and a minimum reward.

1-5. The gaming system of any one or a combination of two or more of 1-1 to 1-4 above and 1-6 to 1-10 below, wherein the gameplay request further comprises a wager value, wherein the wager value determines the specified card patterns and the one or more corresponding award levels that are enabled for determining the reward value for the respective gameplay request.

1-6. The gaming system of any one or a combination of two or more of 1-1 to 1-5 above and 1-7 to 1-10 below, wherein the wager pot processing system comprises a plurality of wager pot pools.

1-7. The gaming system of any one or a combination of two or more of 1-1 to 1-6 above and 1-8 to 1-10 below, wherein the gameplay request further comprises a selection of one of the plurality of wager pot pools.

1-8. The gaming system of any one or a combination of two or more of 1-1 to 1-7 above and 1-9 to 1-10 below, wherein the wager pot processing system is configured to extract a predetermined commission value from at least one of the wager value, the wager pot pool, and the reward value.

1-9. The gaming system of any one or a combination of two or more of 1-1 to 1-8 above and 1-10 below, wherein the specified card patterns include interim patterns corresponding to static reward values of the one or more corresponding award levels and winning patterns corresponding to dynamic reward values of the one or more corresponding award levels for determining the reward value.

1-10. The gaming system of any one or a combination of two or more of 1-1 to 1-9 above, wherein the score sheet further comprises a ball count associated with the specified patterns.

1-11. A method for conducting games, comprising:
receiving a gameplay request from one or more gameplay stations;
evaluating the gameplay request based on one or more corresponding award levels from a score sheet; and
determining a reward value for the gameplay request using the one or more corresponding award levels and a wager pot processing system;
wherein the one or more corresponding award levels include at least a dynamic value based on a wager pot pool of the wager pot processing system.

1-12. The method of any one or a combination of two or more of 1-11 above and 1-13 to 1-20 below, wherein the gameplay request comprises at least a bingo card and a bingo call, and wherein the score sheet comprises specified card patterns with the one or more corresponding award levels for determining the reward value.

1-13. The method of any one or a combination of two or more of 1-11 to 1-12 above and 1-14 to 1-20 below, wherein the award levels comprise a percentage value of the wager pot pool.

1-14. The method of any one or a combination of two or more of 1-11 to 1-13 above and 1-15 to 1-20 below, wherein the award levels comprise a percentage value of the wager pot pool and a minimum reward.

1-15. The method of any one or a combination of two or more of 1-11 to 1-14 above and 1-16 to 1-20 below, wherein the gameplay request further comprises a wager value, wherein the wager value determines the specified card patterns and the one or more corresponding award levels that are enabled for determining the reward value for the respective gameplay request.

1-16. The method of any one or a combination of two or more of 1-11 to 1-15 above and 1-17 to 1-20 below, wherein the wager pot processing system comprises a plurality of wager pot pools.

1-17. The method of any one or a combination of two or more of 1-11 to 1-16 above and 1-18 to 1-20 below, wherein the gameplay request further comprises a selection of one of the plurality of wager pot pools.

1-18. The method of any one or a combination of two or more of 1-11 to 1-17 above and 1-19 to 1-20 below, wherein the wager pot processing system is configured to extract a predetermined commission value from at least one of the wager value, the wager pot pool, and the reward value.

1-19. The method of any one or a combination of two or more of 1-11 to 1-18 above and 1-20 below, wherein the specified card patterns include interim patterns corresponding to static reward values of the one or more corresponding award levels and winning patterns corresponding to dynamic reward values of the one or more corresponding award levels for determining the reward value.

1-20. The method of any one or a combination of two or more of 1-11 to 1-19 above, wherein the score sheet further comprises a ball count associated with the specified patterns.

1-21. A gaming system comprising:
a gaming server in communication one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on one or more corresponding award levels from a score sheet; and
determine a reward value for the gameplay request using the one or more corresponding award levels and a wager pot processing system;
wherein the one or more corresponding award levels include at least a dynamic value based on a wager pot pool of the wager pot processing system.

1-22. The gaming system of any one or a combination of two or more of 1-21 above and 1-23 to 1-31 below,
wherein the gameplay request comprises at least a bingo card and a bingo call, and
wherein the score sheet comprises specified card patterns with the one or more corresponding award levels for determining the reward value.

1-23. The gaming system of any one or a combination of two or more of 1-21 to 1-22 above and 1-24 to 1-31 below, wherein the award levels comprise a percentage value of the wager pot pool.

1-24. The gaming system of any one or a combination of two or more of 1-21 to 1-23 above and 1-25 to 1-31 below, wherein the award levels comprise a percentage value of the wager pot pool and a minimum reward.

1-25. The gaming system of any one or a combination of two or more of 1-21 to 1-24 above and 1-26 to 1-31 below, wherein the gameplay request further comprises a wager value, wherein the wager value determines the specified card patterns and the one or more corresponding award levels that are enabled for determining the reward value for the respective gameplay request.

1-26. The gaming system of any one or a combination of two or more of 1-21 to 1-25 above and 1-27 to 1-31 below, wherein the wager pot processing system comprises a plurality of wager pot pools.

1-27. The gaming system of any one or a combination of two or more of 1-21 to 1-26 above and 1-28 to 1-31 below, wherein the gameplay request further comprises a selection of one of the plurality of wager pot pools.

1-28. The gaming system of any one or a combination of two or more of 1-21 to 1-27 above and 1-29 to 1-31 below, wherein the wager pot processing system is configured to extract a predetermined commission value from at least one of the wager value, the wager pot pool, and the reward value.

1-29. The gaming system of any one or a combination of two or more of 1-21 to 1-28 above and 1-30 to 1-31 below, wherein the specified card patterns include interim patterns corresponding to static reward values of the one or more corresponding award levels and winning patterns corresponding to dynamic reward values of the one or more corresponding award levels for determining the reward value.

1-30. The gaming system of any one or a combination of two or more of 1-21 to 1-29 above and 1-31 below, wherein the score sheet further comprises a ball count associated with the specified patterns.

1-31. The gaming system of any one or a combination of two or more of 1-21 to 1-30 above, wherein the minimum reward is a static value.

1-32. A storage device having instructions stored thereon, which, when executed by one or more processors of a gaming system, configure the one or more processors to perform the method of any one or a combination of two or more of 1-11 to 1-20 above.

1-33. A gaming device comprising:
a memory; and
a processor
the gaming device being configured to communicate with one or more gameplay stations through a communications interface,
the gaming device configured to execute instructions stored on the memory to perform the following steps:
receiving a gameplay request from at least one of the one or more gameplay stations;
evaluating the gameplay request based on one or more corresponding award levels from a score sheet; and
determining a reward value for the gameplay request using the one or more corresponding award levels and a wager pot processing system;
wherein the one or more corresponding award levels include at least a dynamic value based on a wager pot pool of the wager pot processing system.

1-34. The gaming device according to 1-33, wherein the gaming device itself is a gameplay station in communication with other gameplay stations.

1-35. A gaming device comprising:
a memory;
a processor; and
a user interface;
wherein the gaming device is configured to execute instructions stored on the memory to perform the following steps:
receive a gameplay request;
evaluate the gameplay request based on one or more corresponding award levels from a score sheet; and
determine a reward value for the gameplay request using the one or more corresponding award levels and a wager pot processing system;
wherein the one or more corresponding award levels include at least a dynamic value based on a wager pot pool of the wager pot processing system.

1. A gaming system comprising:
one or more gameplay stations, the one or more gameplay stations each including a user interface; and
a gaming server in communication with the one or more gameplay stations through a communications interface, the gaming server comprising a memory and a processor configured for executing instructions stored on the memory to perform the following steps:
receive a gameplay request from at least one of the one or more gameplay stations;
evaluate the gameplay request based on one or more corresponding award levels from a score sheet; and
determine a reward value for the gameplay request using the one or more corresponding award levels and a wager pot processing system;
wherein the one or more corresponding award levels include at least a dynamic value based on a wager pot pool of the wager pot processing system.

2. The gaming system of claim 1,
wherein the gameplay request comprises at least a bingo card and a bingo call, and
wherein the score sheet comprises specified card patterns with the one or more corresponding award levels for determining the reward value.

3. The gaming system of claim 1, wherein the award levels comprise a percentage value of the wager pot pool.

4. The gaming system of claim 1, wherein the award levels comprise a percentage value of the wager pot pool and a minimum reward.

5. The gaming system of claim 2, wherein the gameplay request further comprises a wager value, wherein the wager value determines the specified card patterns and the one or more corresponding award levels that are enabled for determining the reward value for the respective gameplay request.

6. The gaming system of claim 1, wherein the wager pot processing system comprises a plurality of wager pot pools.

7. The gaming system of claim 6, wherein the gameplay request further comprises a selection of one of the plurality of wager pot pools.

8. The gaming system of claim 7, wherein the wager pot processing system is configured to extract a predetermined commission value from at least one of the wager value, the wager pot pool, and the reward value.

9. The gaming system of claim 2, wherein the specified card patterns include interim patterns corresponding to static reward values of the one or more corresponding award levels and winning patterns corresponding to dynamic reward values of the one or more corresponding award levels for determining the reward value.

10. The gaming system of claim 2, wherein the score sheet further comprises a ball count associated with the specified patterns.

11. A method for conducting games, the method comprising:
receiving a gameplay request from one or more gameplay stations;
evaluating the gameplay request based on one or more corresponding award levels from a score sheet; and
determining a reward value for the gameplay request using the one or more corresponding award levels and a wager pot processing system;
wherein the one or more corresponding award levels include at least a dynamic value based on a wager pot pool of the wager pot processing system.

12. The method of claim 11, wherein the gameplay request comprises at least a bingo card and a bingo call, and
wherein the score sheet comprises specified card patterns with the one or more corresponding award levels for determining the reward value.

13. The method of claim 11, wherein the award levels comprise a percentage value of the wager pot pool.

14. The method of claim 11, wherein the award levels comprise a percentage value of the wager pot pool and a minimum reward.

15. The method of claim 12, wherein the gameplay request further comprises a wager value, wherein the wager value determines the specified card patterns and the one or more corresponding award levels that are enabled for determining the reward value for the respective gameplay request.

16. The method of claim 11, wherein the wager pot processing system comprises a plurality of wager pot pools.

17. The method of claim 16, wherein the gameplay request further comprises a selection of one of the plurality of wager pot pools.

18. The method of claim 17, wherein the wager pot processing system is configured to extract a predetermined commission value from at least one of the wager value, the wager pot pool, and the reward value.

19. The method of claim 12, wherein the specified card patterns include interim patterns corresponding to static reward values of the one or more corresponding award levels and winning patterns corresponding to dynamic reward values of the one or more corresponding award levels for determining the reward value.

20. The method of claim 12, wherein the score sheet further comprises a ball count associated with the specified patterns.
